(19) United States
(12) Patent Application Publication
(10) Pub. No.: US 2024/0045349 A1
(43) Pub. Date: Feb. 8, 2024

(54) TONER AND METHOD FOR PRODUCING SAME AS WELL AS DEVELOPER CONTAINING SAME AND IMAGE FORMING DEVICE USING SAME

(71) Applicant: SHARP KABUSHIKI KAISHA, Osaka (JP)

(72) Inventor: TADANORI KANO, Osaka (JP)

(21) Appl. No.: 18/228,714

(22) Filed: Aug. 1, 2023

(30) Foreign Application Priority Data
Aug. 5, 2022 (JP) 2022-125613

(51) Int. Cl. G03G 9/08; G03G 9/097; G03G 9/087

(52) U.S. Cl. CPC G03G 9/0815; G03G 9/09708; G03G 9/09725; G03G 9/08755; G03G 9/0819; G03G 9/0808

(57) ABSTRACT

Provided is a toner having low-temperature fixability and excellent heat-resistant storage stability, controlling charge reduction of a developer due to development stress, and being able to maintain high image quality throughout the product life (life), and the method for producing the toner, and the developer containing the toner and the image forming device using the developer. The toner includes: toner core particles containing at least a binder resin and a release agent; and external additives externally added to surfaces of the toner core particles. The binder resin contains a crystalline polyester-based resin, the toner core particles have a viscosity at 90° C. of 100000 to 250000 Pa·s, the external additives are small size silica particles hydrophobized and barium titanate particles hydrophobized, and the barium titanate particles have an average primary particle size of 20 to 40 nm and a coverage of 2 to 7% for the toner core particles.

### TECHNICAL FIELD

The present disclosure relates to a toner and a method for producing the toner as well as a developer containing the toner and an image forming device using the developer. More specifically, the present disclosure relates to a toner having low-temperature fixability and excellent heat-resistant storage stability, controlling charge reduction of the developer due to development stress, and being able to maintain high image quality throughout the product life (life), and a method for producing the toner, as well as a developer containing the toner and an image forming device using the developer.

### BACKGROUND ART

In recent years, with the remarkable development of office automation equipment, image forming devices (electrophotographic apparatuses), such as digital copiers, printers, and facsimile machines using an electrophotographic system, have been widespread.

In addition, with the increase in deployment of contact charging systems using roller charging and the growing trend toward longer life, smaller size, and higher speed of image forming devices, image forming devices and toners used in them are required to have various functions.

For example, increasing the low-temperature fixation of toner more than ever requires that toner core particles be covered with many silica particles to ensure heat-resistant storage stability. This has caused difficulties including: the toner covered with many silica particles has a large environmental charge difference; and in a developer containing a low-temperature fixing toner, an external additive becomes likely to be embedded because of the stress due to a doctor blade. Thus, a charge control agent is used to reduce the environmental charge difference. However, this increases the environmental charge difference when the charge control agent itself embeds in the toner. In addition to the environmental charge difference, charge change due to development stress is added, and this has caused a defective image, such as an image density (ID) decrease and/or fog occurrence.

Thus, a ratio (allocation) between the amount of silica particles and the amount of charge control agent that results in a smaller environmental charge difference has been found and applied. In addition, a method of reducing the embedding of the charge control agent by increasing the particle size of the charge control agent has been also applied, but this has reduced the specific surface area of the charge control agent and may have reduced the charge control ability. Thus, it has become more difficult to maintain the minimum amount of silica particles required to ensure the heat-resistant storage stability of low-temperature fixing toners and to satisfy the environmental charging performance of the entire product life of the developer, including the controlling of the charging change due to the embedding of the charge control agent.

Techniques for overcoming such difficulties of the toner have been proposed.

For example, an electrostatic latent image developing toner containing a plurality of toner particles is proposed, in which
each toner particle includes a toner core and a shell layer covering the toner core,
the shell layer contains a thermosetting resin and a thermoplastic resin,
the toner core contains at least a polyester resin,
a melt viscosity of the toner particles at 80° C. is 2.1×10⁴ Pa·s or greater and 2.3×10⁵ Pa·s or less, and
a melt viscosity of the toner particles at 90° C. is 7.0×10³ Pa·s or greater and 2.3×10⁴ Pa·s or less,

and an external additive is exemplified by barium titanate.

### SUMMARY

### Technical Problem

The present disclosure has been made in view of the above circumstances, and an object of the present disclosure is to provide a toner having low-temperature fixability and excellent heat-resistant storage stability, controlling charge reduction of the developer due to development stress, and being able to maintain high image quality throughout the product life (life), and a method for producing the toner, as well as a developer containing the toner and an image forming device using the developer.

### Solution to Problem

As a result of diligent studies conducted to solve the above difficulties, the present inventor has found the following and completed the disclosure: a toner having low-temperature fixability and excellent heat-resistant storage stability, controlling charge reduction of a developer due to development stress, and being able to maintain high image quality throughout the product life (life), and a developer containing the toner are produced by using a toner including:
toner core particles containing at least a polyester-based resin and a release agent and having a specific viscosity; and
external additives externally added to surfaces of the toner core particles,
in which the external additives are silica particles hydrophobized (small size silica particles) and barium titanate particles hydrophobized with a specific average primary particle size and a specific coverage for the toner core particles.

The proposed technique above does not disclose a specific coverage of barium titanate and an effect due to the coverage.

Thus, according to the present disclosure, there is provided a toner including:
toner core particles containing at least a binder resin and a release agent; and
external additives externally added to surfaces of the toner core particles,
wherein
   the binder resin contains a crystalline polyester-based resin,
   the toner core particles have a viscosity at 90° C. of 100000 to 250000 Pa·s,
   the external additives are small size silica particles hydrophobized and barium titanate particles hydrophobized, and
   the barium titanate particles have an average primary particle size of 20 to 40 nm and a coverage of 2 to 7% for the toner core particles.

In addition, according to the present disclosure, there is provided a method for producing the toner described above, the method including:
externally adding the external additive to the toner core particles by adding and mixing the external additive of the barium titanate particles to the toner core particles; and
externally adding the external additive to the first externally added toner core particles by further adding and mixing the external additive of the small size silica particles to the first externally added toner core particles.

Furthermore, according to the present disclosure, there is provided a method for producing the toner described above, the toner further containing, as an external additive, large size silica particles with an average primary particle size of 70 to 200 nm, the method including:
externally adding the external additive to the toner core particles by adding and mixing the external additive of the barium titanate particles to the toner core particles;
externally adding the external additive to the first externally added toner core particles by further adding and mixing the external additive of the small size silica particles to the first externally added toner core particles; and
externally adding the external additive to the second externally added toner core particles by further adding and mixing the external additive of the large size silica particles to the second externally added toner core particles.

Moreover, according to the present disclosure, there is provided a developer containing the toner described above and a carrier.

Still more, according to the present disclosure, there is provided an image forming device that forms an image by forming an electrostatic latent image on a surface of an electrophotographic photoreceptor and transferring a toner developed on the electrostatic latent image to a transfer receiving material, in which the toner is the toner described above.

### Advantage Effects of Invention

According to the present disclosure, there can be provided a toner having low-temperature fixability and excellent heat-resistant storage stability, controlling charge reduction of a developer due to development stress, and being able to maintain high image quality throughout the product life (life), and a method for producing the toner, as well as a developer containing the toner and an image forming device using the developer.

That is, the present inventor believes that because barium titanate particles are highly capable of reducing the environmental charge difference per unit area covered with a charge control agent, the use of the barium titanate particles reduces the covering amount of the charge control agent; this increases the environmental charge difference in the developer in the initial stage but can reduce the change in the entire product life of the developer; and moving the barium titanate particles to depressions on the toner surfaces by combined use with the small size silica particles can reduce the embedding of the barium titanate particles in the toner surface and control the deterioration of fog or the like in the life.

### BRIEF DESCRIPTION OF DRAWINGS

FIG. 1 is a graph showing a relationship between temperature and melt viscosity of toner core particles.

FIG. 2 is a schematic side view illustrating an example of a configuration of a main portion of an image forming device of the present disclosure.

### DESCRIPTION OF EMBODIMENTS

### (1) Toner

A toner of the present disclosure includes: toner core particles containing at least a binder resin

and a release agent; and external additives externally added to surfaces of the toner core particles. The binder resin contains a crystalline polyester-based resin. The toner core particles have a viscosity at 90° C. of 100000 to 250000 Pa·s. The external additives are small size silica particles hydrophobized and barium titanate particles hydrophobized. The barium titanate particles have an average primary particle size of 20 to 40 nm and a coverage of 2 to 7% for the toner core particles. Hereinafter, a mechanism of exhibiting the effect of the toner of the present disclosure, the toner core particles and the external additives, which are characteristic portions of the toner, will be described, and a method for producing the toner, a developer containing the toner, and an image forming device using the developer will be described.

The present inventor considers the mechanism of exhibiting the effect of the toner of the present disclosure and its guiding principle as follows.

Low-temperature fixing of the toner can be achieved by increasing the amount of the crystalline polyester-based resin as the binder resin in the toner core particles. On the other hand, the external additive on the toner surface is embedded in the toner core particles by physical stress in a developing tank of an image forming device and becomes unable to contribute to frictional charging. This results in exhibiting a charging behavior similar to that in reducing the external addition amount of the external additive.

The degree of embedding of the external additive can be grasped by drawing a calibration curve with data collected from measurement of charge amounts of toners with increased and reduced external addition amounts and comparing the charge amount of the developer in the final stage of the product life with the calibration curve. In addition, the embedded amount can be checked by observing and comparing the developer in the initial stage and the developer in the final stage of the product life with a scanning electron microscope.

The developer needs to maintain high image quality even in a low humidity environment and a high humidity environment from the initial stage to the final stage of the product life, and the charge control agent needs to remain in a certain amount without embedding also in the final stage of the product life. The charge control agent widely distributed on the toner surface has high probability of undergoing physical stress. Many depressions are present on the surface of the toner core particles prepared by a pulverization method. If the charge control agent fits into the depressions, the charge control agent would be less likely to undergo physical stress. However, the proportion of the area of the depressions and grooves is small compared with the total area and is insufficient.

A material, such as alumina or strontium titanate, has been used as the charge control agent, that is to say, a material with a resistance value lower than that of the toner core particles has been used. The charge control agent with a low resistance value is considered to serve to make the distribution of charges uniform to some extent when the charges are unevenly distributed on the toner surface by frictional charging, but the dielectric constant of the charge control agent is also considered to affect as another function.

The present inventor externally added, to the toner core particles, each of alumina (AL), strontium titanate (TS), or barium titanate (TB) having the same particle size and subjected to the same surface treatment, pelletized those toners with the external additive, and measured the capacitance: the capacitance resulted in the order of AL<TS<TB as same as that of the dielectric constant. In addition, toners with an increased or reduced external addition amount of the charge control agent of these were prepared, and the environmental charging performance was measured: the improvement of the environmental charging performance per covered area of the charge control agent also resulted in the order of AL<TS<TB.

From the above results, the present inventor considered as follows. TB has a strong ability to improve the environmental charging performance per covered area, and thus the external addition amount can be reduced. TB has a large specific gravity, and thus the covered area calculated by the projection method is smaller than that of AL and TS in terms of the same mass %. Thus, TB can maintain the environmental charging performance until the final stage of the product life with an amount allowing TB to fit into the depressions and grooves of the toner surfaces.

In addition, the present inventor has studied the necessity to figure out a way to handle external addition to move the barium titanate particles to the depressions of the toner surfaces. Experience up to now shows that in the case where the charge control agent has high circularity, the fluidity of the toner tends to increase when the surface treatment agent for hydrophobization has small molecular weight. Thus, studies were carried out focusing on the order of external additions and the difference in particle sizes of the external additives. The present inventor then found the following.

The barium titanate particles are externally added in a first external addition, and silica, which has a smaller particle size than the barium titanate particles, is externally added in a second external addition, and this allows the barium titanate particles to be flowed away by silica, which is smaller than the barium titanate particles, and to fit into depressions of the toner surfaces.

This increases the adhesion strength, and thus the behavior of the particles on the toner surfaces can be distinguished by EDX mapping with a scanning electron microscope or the like.

Furthermore, silica with a larger particle size (e.g., from 70 to 200 nm) than that of the silica in the second external addition is externally added in a third external addition, and this results in a form where the large silica covers the depressions into which the barium titanate particles fitted and can avoid physical stress during development.

A sufficient amount of the externally added barium titanate particles needs to fit into the depressions on the toner surfaces, and this state can be checked by the mobility of the barium titanate particles.

As will be described later, the mobility of the barium titanate particles can be measured by measuring and comparing the adhesion strength of the barium titanate particles before and after stirring the toner with the external additive of the barium titanate particles. The present inventor has confirmed that the additional stirring does not greatly increase the adhesion strength if the barium titanate particles are already flowed by the external addition treatment and sufficiently fit into the depressions.

### (1-1) External Additives

The external additive usually has functions of improving the conveying property and charging property of the toner as well as the stirring property with a carrier when the toner is used as a two-component developer.

The toner of the present disclosure contains small size silica particles hydrophobized and barium titanate particles hydrophobized.

### (1-1-1) Barium Titanate Particles

The hydrophobized barium titanate particles used in the present disclosure have an average primary particle size of 20 to 40 nm and a coverage of 2 to 7% for the toner core particles. In addition, the barium titanate particles are preferably in the form of particles but may be in the form, such as spheres, needles, or non-spheres, and the barium titanate particles may have either a structure of a single particle or a structure in which several pluralities of particles are aggregated.

Examples of the barium titanate particles include silica particles hydrophobized by a surface treatment commonly used in the art, such as the surface treatment with hexamethyldisilazane (HMDS), dimethyl-dichlorosilane (DDS), octylsilane (OTAS), and/or polydimethylsiloxane (PDMS). Even when silica particles are not hydrophobized, they can be used only after subjected to hydrophobization treatment.

The barium titanate particles with an average primary particle size less than 20 nm may cause an image density (ID) decrease in a low humidity environment and/or an increase in a fog value in a high humidity environment in the developer in the final stage of the product life. On the other hand, the barium titanate particles with an average primary particle size greater than 40 nm may cause an ID decrease in a low humidity environment and/or an increase in a fog value in a high humidity environment in the developer in the initial stage.

The average primary particle size of the barium titanate particles is preferably from 25 to 35 nm.

The barium titanate particles with a coverage less than 2% for the toner core particles may cause an ID decrease in a low humidity environment and/or an increase in a fog value in a high humidity environment in the developer in the final stage of the product life. On the other hand, the barium titanate particles with a coverage greater than 7% may cause an increase in a fog value in a high humidity environment in the developer in the initial stage.

A preferred coverage of the barium titanate particles is from 2 to 5%.

### Adhesion Strength

When the toner is subjected to an external additive removal treatment and SA2 and SB2 are measured by X-ray fluorescence analysis, an adhesion strength (SA2/SB2)×100 of the barium titanate particles is preferably 80% or greater. SA2 is an intensity of elementary barium Ba in 1 g of a resulting toner after the external additive removal treatment, and SB2 is an intensity of elementary barium Ba in 1 g of the toner before the external additive removal treatment. The external additive removal treatment includes: adding 2.0 g of the toner to 40 mL of a poly(oxyethylene) octylphenyl ether aqueous solution with a concentration of 0.2 mass % to form a mixed solution and stirring the mixed solution for 1 minute; irradiating the stirred solution with an ultrasonic wave with an output of 40 μA for 4 minutes; allowing the irradiated solution to stand for 3 hours; separating the toner and the external additives released; removing a supernatant from the separated solution; subsequently adding about 50 mL of pure water to a precipitate of the separated solution to form a mixture and stirring the mixture for 5 minutes; suction-filtering the stirred mixture using a membrane filter with a pore size of 1 μm; and vacuum-drying the toner remaining on the membrane filter overnight to produce the resulting toner after the external additive removal treatment.

The barium titanate particles with an adhesion strength (SA2/SB2)×100 less than 80% may cause an ID decrease in a low humidity environment and/or an increase in a fog value in a high humidity environment in the developer in the final stage of the product life.

A preferred adhesion strength is 95% or greater and more preferably 98% or greater. The measurement of the adhesion strength will be specifically described in Examples.

### Mobility

When the toner is subjected to stirring treatment and FA and FB are measured, a mobility (FB/FA)×100 of the barium titanate particles is preferably 1.1 or less. FB is an adhesion strength of barium titanate of a resulting content of the toner after the stirring treatment, and FA is an adhesion strength of barium titanate of the toner before the stirring treatment. The stirring treatment includes: placing the toner in a stainless-steel container with a capacity of 500 mL; and stirring the toner in a stainless-steel container at a circulating speed of a stirring blade tip of 40 m/s for 180 seconds.

The barium titanate particles with a mobility (FB/FA)×100 greater than 1.1 may cause an ID decrease in a low humidity environment and/or an increase in a fog value in a high humidity environment in the developer in the final stage of the product life.

The mobility is preferably 0.7 or greater.

The measurement of the mobility will be specifically described in Examples.

### Distribution Deviation Value

When the toner is subjected to a qualitative and quantitative analysis with a scanning electron microscope and BF and BH are measured, a distribution deviation value (BH/BF) of the barium titanate particles is preferably 2.0 or greater. BF is an average value of proportions of elementary barium Ba in flat portions, and BH is an average value of proportions of elementary barium Ba in depressed portions. In the qualitative and quantitative analysis, for 50 particles of the toner, two depressed portions, such as a step and a groove, and two flat portions with no depression on a surface of each of the 50 particles, 200 points in total are analyzed.

The barium titanate particles with a distribution deviation value less than 2.0 may cause an ID decrease in a low humidity environment and/or an increase in a fog value in a high humidity environment in the developer in the final stage of the product life.

The distribution deviation value is preferably 2.1 or greater.

The measurement of the distribution deviation value will be specifically described in Examples.

### (1-1-2) Small Size Silica Particles

The hydrophobized small size silica particles used in the present disclosure preferably have an average primary particle size smaller than the barium titanate particles, and the average primary particle size PS of the small size silica particles and the average primary particle size PB of the barium titanate particles preferably satisfy a relationship of PS<PB.

The small size silica particles and the barium titanate particles not satisfying the above relationship, that is, the small size silica particles with an average primary particle size PS not less than the average primary particle size PB of the barium titanate particles may cause an ID decrease in a low humidity environment and/or an increase in a fog value in a high humidity environment in the developer in the final stage of the product life.

The average primary particle size of the small size silica particles is not particularly limited but is preferably from 6 to 16 nm.

The small size silica particles preferably have a coverage of 70 to 90% for the toner core particles. The small size silica particles with a coverage less than 70% for the toner core particles would lack sufficient heat-resistant storage capability in the toner produced using the toner core particles with a viscosity at 90° C. of 100000 to 250000 Pa·s and may not be able to store the product with the quality maintained. On the other hand, the small size silica particles with a coverage greater than 90% would reduce the adhesion strength of another or other types of external additives and may cause an ID decrease in a low humidity environment and/or an increase in a fog value in a high humidity environment in the developer in the final stage of the product life.

A more preferred coverage of the small size silica particles is from 80 to 90%.

Examples of the small size silica particles include silica particles hydrophobized by a surface treatment commonly used in the art, such as the surface treatment with hexamethyldisilazane (HMDS), dimethyl-dichlorosilane (DDS), octylsilane (OTAS), and/or polydimethylsiloxane (PDMS). Even when silica particles are not hydrophobized, they can be used only after subjected to hydrophobization treatment.

The origin of the small size silica particles is not particularly limited; for example, silica particles produced by subjecting silica to hydrophobization treatment can be used, the silica produced by a method, such as a flame hydrolysis method, in which silicon tetrachloride is burned in an oxyhydrogen flame, or a sol-gel method.

### (1-1-3) Large Size Silica Particles

The toner of the present disclosure preferably further contains as an external additive large size silica particles with an average primary particle size of 70 to 200 nm in addition to the small size silica particles and the barium titanate particles.

The large size silica particles with an average primary particle size less than 70 nm may fail to exhibit an effect of controlling an ID decrease in a low humidity environment and/or an effect of further controlling an increase in a fog value in a high humidity environment in the developer in the final stage of the product life. On the other hand, the large size silica particles with an average primary particle size greater than 200 nm may have a weak adhesion strength, detach themselves from the toner, and cause an image defect, such as filming.

A preferred average primary particle size of the large size silica particles is from 90 to 130 nm.

Examples of the large size silica particles include silica particles hydrophobized by a surface treatment commonly used in the art, such as the surface treatment with hexamethyldisilazane (HMDS), dimethyl-dichlorosilane (DDS), octylsilane (OTAS), and/or polydimethylsiloxane (PDMS). Even when silica particles are not hydrophobized, they can be used only after subjected to hydrophobization treatment.

The origin of the large size silica particles is not particularly limited; for example, silica particles produced by subjecting silica to hydrophobization treatment can be used, the silica produced by a method, such as a flame hydrolysis method, in which silicon tetrachloride is burned in an oxyhydrogen flame, or a sol-gel method.

The large size silica particles preferably have a coverage of 3 to 14% for the toner core particles. The large size silica particles with a coverage less than 3% with respect to the toner core particles may fail to exhibit an effect of controlling an ID decrease in a low humidity environment and/or an effect of further controlling an increase in a fog value in a high humidity environment in the developer in the final stage of the product life. On the other hand, the large size silica particles with a coverage greater than 14% may cause an image defect, such as filming.

A more preferred coverage of the large size silica particles is from 3 to 11%.

### (1-2) Toner Core Particles

The toner core particles contained in the toner of the present disclosure contain at least a binder resin and a release agent and may contain a known additive, such as a colorant and a charge control agent, as necessary to the extent that the effects of the present disclosure are not inhibited.

### Viscosity at 90° C.

The toner core particles of the present disclosure have a viscosity at 90° C. of 100000 to 250000 Pa·s.

The toner core particles with a viscosity at 90° C. less than 100000 Pa·s may cause an ID decrease in a low humidity environment and/or an increase in a fog value in a high humidity environment in the developer in the final stage of the product life. On the other hand, toner core particles with a viscosity at 90° C. greater than 250000 Pa·s would make it difficult to form toner core particles having the low-temperature fixability of the toner of the disclosure.

A preferred viscosity of the toner core particles at 90° C. is from 120000 to 180000 Pa·s. The measurement of the viscosity will be specifically described in Examples.

### BET Specific Surface Area

The toner core particles of the present disclosure preferably have a BET specific surface area of 0.5 to 2.5 m²/g defined in JIS Z8830: 2013.

The toner core particles with a BET specific surface area less than 0.5 m²/g may cause an ID decrease in a low humidity environment and/or an increase in a fog value in a high humidity environment in the developer in the final stage of the product life. On the other hand, the toner core particles with a BET specific surface greater than 2.5 m²/g may cause an increase in a fog value in a high humidity environment in the developer in the initial stage.

A more preferred BET specific surface area of the toner core particles is from 0.6 to 2.4 m²/g and more preferably from 1.8 to 2.4 m²/g.

### Average Primary Particle Size

The toner core particles preferably have an average primary particle size of 5 to 7 μm.

The toner core particles with an average primary particle size in the above range can achieve the objects of high definition of the image and reduction in toner consumption in the initial design stage.

The measurement of the average primary particle size will be specifically described in Examples.

### (1-2-1) Binder Resin

The binder resin contained in the toner core particles of the present disclosure contains a crystalline polyester-based resin.

Examples of the binder resin include polyester-based resin, polystyrene-based resins like styrene-acrylic resins, (meth)acrylic ester-based resins, polyolefin-based resins, polyurethane-based resins, and epoxy-based resins, and one of these resins can be used individually, or two or more in combination. Among these, a polyester-based resin is preferred because physical properties of the resin can be easily controlled by setting the conditions for the polycondensation reaction as described below, and a binder resin having desired physical properties can be produced.

Thus, the binder resin may contain an additional resin as long as the binder resin contains a crystalline polyester-based resin, but a combination with an amorphous polyester-based resin is preferred.

The polyester-based resin used for the binder resin is usually produced by subjecting one or more selected from the group consisting of dihydric alcohol components and trihydric or higher polyhydric alcohol components and one or more selected from the group consisting of divalent carboxylic acids and trivalent or higher polyvalent carboxylic acids to a polycondensation reaction through an esterification reaction or a transesterification reaction by a known method.

The conditions in the condensation polymerization reaction are to be appropriately set according to the reactivity of the monomer components, and the reaction is to be terminated when the polymer has suitable physical properties. For example, the reaction temperature is approximately from 170 to 250° C., and the reaction pressure is approximately from 5 mm Hg to normal pressure.

Examples of the dihydric alcohol component include alkylene oxide adducts of bisphenol A, such as poly(oxypropylene)(2.2)-2,2-bis(4-hydroxyphenyl)propane, poly(oxypropylene) (3.3)-2,2-bis(4-hydroxyphenyl)propane, poly(oxypropylene)(2.0)-2,2-bis(4-hydroxyphenyl)propane, poly(oxypropylene)(2.0)-poly(oxyethylene)(2.0)-2,2-bis(4-hydroxyphenyl)propane, and poly(oxypropylene)(6)-2,2-bis(4-hydroxyphenyl)propane; diols, such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenol A; propylene adducts of bisphenol A; ethylene adducts of bisphenol A; and hydrogenated bisphenol A.

Examples of the trihydric or higher polyhydric alcohol component include sorbitol, 1,2,3,6-hexanetetrol, 1,4-sorbitan, pentaerythritol, dipentaerythritol, tripentaerythritol, sucrose (cane sugar), 1,2,4-butanetriol, 1,2,5-pentanetriol, glycerol, 2-methylpropanetriol, 2-methyl-1,2,4-butanetriol, trimethylolethane, trimethylolpropane, and 1,3,5-trihydroxymethylbenzene.

In the present disclosure, one of the dihydric alcohol components and trihydric or higher polyhydric alcohol components may be used individually, or two or more in combination. Examples of the divalent carboxylic acid include maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-dodecenylsuccinic acid, n-dodecylsuccinic acid, n-octylsuccinic acid, isooctenylsuccinic acid, isooctylsuccinic acid, and acid anhydrides and lower alkyl esters of these.

Examples of the trivalent or higher polycarboxylic acid include 1,2,4-benzenetricarboxylic acid, 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, Empol trimer acid, and acid anhydrides and lower alkyl esters of these.

In the present disclosure, one of the divalent carboxylic acids and trivalent or higher polyvalent carboxylic acids may be used individually, or two or more in combination.

The binder resin of the toner core particles of the toner of the present disclosure contains a crystalline polyester-based resin and preferably further contains an amorphous polyester-based resin.

In the present disclosure, the crystalline resin and the amorphous resin are distinguished by a crystallinity index; resins with a crystallinity index in a range of 0.6 to 1.5 are classified as crystalline resins, and resins with a crystallinity index less than 0.6 or greater than 1.5 are classified as amorphous resins. Resins with a crystallinity index greater than 1.5 are amorphous, and resins with a crystallinity index less than 0.6 have low crystallinity and many amorphous parts. The crystallinity index is an indicator of the degree of crystallinity and is defined by the ratio of the softening temperature to the maximum endothermic peak temperature (softening temperature/maximum endothermic peak temperature). Here, the maximum endothermic peak temperature refers to the temperature of the peak on the highest temperature side among the endothermic peaks observed. In the crystalline polyester-based resin, the maximum peak temperature is taken as the melting point, and in the amorphous polyester-based resin, the peak on the highest temperature side is taken as the glass transition point.

The degree of crystallinity can be controlled by adjusting the types and ratios of raw material monomers, production conditions (e.g., reaction temperature, reaction time, and cooling rate), and the like.

The crystalline polyester-based resin is a polyester-based resin with a crystallinity index of 0.6 to 1.5 but is preferably a polyester-based resin with a crystallinity index of 0.8 to 1.2. In addition, the crystalline polyester-based resin is produced, for example, by polycondensation of a polybasic acid and a polyhydric alcohol. For example, it can be produced by a known method, such as that described in JP 2006-113473 A.

The acid value of the crystalline polyester-based resin is preferably from 5 to 20 mg KOH/g. In addition, the hydroxyl value of the crystalline polyester-based resin is preferably from 5 to 20 mg KOH/g.

For the molecular weight of the crystalline polyester-based resin, the weight average molecular weight (Mw) is preferably from 5000 to 100000, and the number average molecular weight (Mn) is preferably from 3000 to 20000. In the present disclosure, the weight average molecular weight and the number average molecular weight are values measured by gel permeation chromatography (GPC), using chloroform as a mobile phase and polystyrene as a standard material.

The softening temperature of the crystalline polyester-based resin is preferably from 60 to 105° C.

In the toner according to the present disclosure, the content of the crystalline polyester-based resin is not particularly limited but is preferably 1 mass % or greater and 20 mass % or less and more preferably from 2 to 20 mass % in the toner particles. The crystalline polyester-based resin contained in the amount not less than the above lower limit can facilitate improving the low-temperature fixability. The crystalline polyester-based resin contained in the amount not greater than the above upper limit can facilitate improving the heat-resistant storage property of the toner.

The amorphous polyester-based resin is a polyester-based resin with a crystallinity index less than 0.6 or greater than 1.5, but a polyester-based resin with a crystallinity index greater than 1.5 is preferred. In addition, the amorphous polyester-based resin is produced, for example, by polycondensation of a polybasic acid and a polyhydric alcohol.

For the polybasic acid, a known monomer for polyester synthesis can be used; examples include aromatic carboxylic acids, such as terephthalic acid, isophthalic acid, phthalic anhydride, trimellitic acid, trimellitic anhydride, pyromellitic acid, and naphthalenedicarboxylic acid; aliphatic carboxylic acids, such as maleic anhydride, fumaric acid, succinic acid, alkenyl succinic anhydrides, and adipic acid; and methyl esters of these polybasic acids. One of these polybasic acids may be used individually, or two or more in combination.

Also, for the polyhydric alcohol, a known monomer for polyester synthesis can be used; examples include aliphatic polyhydric alcohols, such as ethylene glycol, propylene glycol, butanediol, hexanediol, neopentyl glycol, and glycerol; alicyclic polyhydric alcohols, such as cyclohexanediol, cyclohexanedimethanol, and hydrogenated bisphenol A; and aromatic diols, such as ethylene oxide adducts of bisphenol A and propylene oxide adducts of bisphenol A. One of these polyhydric alcohols may be used individually, or two or more in combination.

The polycondensation reaction of the polybasic acid and the polyhydric alcohol can be carried out according to a common method; for example, the polycondensation reaction is carried out by bringing the polybasic acid and the polyhydric alcohol into contact with each other in the presence or absence of an organic solvent and in the presence of a polycondensation catalyst (such as tin octylate), and the reaction is terminated when the acid value and/or the softening temperature of the resulting polyester reaches a desired value. This produces the amorphous polyester-based resin. Using a methyl ester of the polybasic acid as part of the polybasic acid allows demethanol polycondensation reaction to proceed. In this polycondensation reaction, for example, the carboxyl group content at the end of the polyester can be adjusted by appropriately changing the mixing ratio, reaction ratio, and/or the like of the polybasic acid and the polyhydric alcohol, and this can in turn modify the properties of the resulting amorphous polyester-based resin. In addition, using trimellitic anhydride as the polybasic acid can easily introduce a carboxyl group into the main chain of the polyester.

Furthermore, the polycondensation reaction of the polybasic acid and the polyhydric alcohol is usually carried out under a temperature condition of 150 to 300° C. and preferably of approximately 170 to 280° C. Moreover, the polycondensation reaction polycondensation reaction can be carried out under normal pressure, reduced pressure, or increased pressure, but the pressure in the system is desirably adjusted appropriately with monitoring of the progress of the polycondensation reaction by physical properties (e.g., such as the acid value and/or melting point), and/or the stirring torque or power value of the reactor.

The acid value of the amorphous polyester-based resin is preferably from 10 to 30 KOH mg/g and more preferably from 15 to 25 KOH mg/g.

The weight average molecular weight (Mw) of the amorphous polyester-based resin is preferably from 5000 to 50000, and the number average molecular weight (Mn) is preferably from 1000 to 10000. In the present disclosure, the weight average molecular weight and the number average molecular weight are values measured by gel permeation chromatography (GPC), using tetrahydrofuran (THF) as a mobile phase and polystyrene as a standard material.

The glass transition temperature (Tg) of the amorphous polyester-based resin is preferably from 55 to 70° C.

In the toner according to the present disclosure, the content of the amorphous polyester-based resin is not particularly limited but is preferably from 67 to 89 mass % in the toner core particles.

### (1-2-2) Release Agent

For the release agent contained in the toner core particles of the present disclosure, a release agent commonly used in the art can be used.

Examples include petroleum-based waxes, such as paraffin waxes, microcrystalline waxes, and their derivatives; hydrocarbon-based synthetic waxes, such as Fischer-Tropsch waxes, polyolefin waxes (such as polyethylene waxes and polypropylene waxes), low molecular weight polypropylene waxes, and polyolefin-based polymer waxes (such as low molecular weight polyethylene waxes), and their derivatives; plant-based waxes, such as carnauba waxes, rice waxes, candelilla waxes, and their derivatives, and Japan waxes; animal waxes, such as beeswaxes and spermaceti waxes; oil and/or fat-based synthetic waxes, such as fatty acid amides and phenolic fatty acid esters; long-chain carboxylic acids and their derivatives; long-chain alcohols and their derivatives; silicone-based polymers; and higher fatty acids. Among these, a hydrocarbon-based synthetic wax is preferred.

The above derivatives include oxides; block copolymers of vinyl monomers and waxes, and graft-modified products of vinyl monomers and waxes.

In the present disclosure, one of the above release agents can be used individually, or two or more in combination.

The release agent preferably has a melting point of 70° C. or lower from the viewpoint of an effect of achieving both low-temperature fixability and hot offset resistance, particularly low-temperature fixability. The lower limit of the melting point is approximately 60° C.

The content of the release agent in the toner core particles of the present disclosure is not particularly limited but is preferably from 0.2 to 20 parts by mass, more preferably from 0.5 to 10 parts by mass, and particularly preferably from 1.0 to 8.0 parts by mass per 100 parts by mass of the binder resin.

The release agent contained in the amount in the above range enables formation of an image with high image density and very good image quality without impairing various physical properties of the toner.

The content of the release agent in terms of that in the toner core particles is preferably from 2.0 to 7.0 mass% and more preferably from 3.0 to 5.0 mass %.

### (1-2-3) Colorant

For the colorant contained in the toner core particles of the present disclosure, an organic and/or inorganic pigment and/or dye of various types and/or colors can be used; examples include black, white, yellow, orange, red, purple, blue, and green colorants.

Examples of the black colorant include carbon black, copper oxide, manganese dioxide, aniline black, activated carbon, nonmagnetic ferrite, magnetic ferrite, and magnetite.

Examples of the white colorant include zinc oxide, titanium oxide, antimony white, and zinc sulfide.

Examples of the yellow colorant include chrome yellow, zinc yellow, cadmium yellow, yellow iron oxide, mineral fast yellow, nickel titanium yellow, navel yellow, naphthol yellow S, Hansa yellow G, Hansa yellow 10G, benzidine yellow G, benzidine yellow GR, quinoline yellow lake, Permanent Yellow NCG, tartrazine lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, and C.I. Pigment Yellow 138.

Examples of the orange colorant include red chrome yellow, molybdenum orange, Permanent Orange GTR, pyrazolone orange, vulcan orange, Indanthrene Brilliant Orange RK, benzidine orange G, Indanthrene Brilliant Orange GK, C.I. Pigment Orange 31, and C.I. Pigment Orange 43.

Examples of the red colorant include red iron oxide, cadmium red, red lead, mercury sulfide, cadmium, Permanent Red 4R, Lithol Red, pyrazolone red, watching red, calcium salts, Lake Red C, Lake Red D, Brilliant Carmine 6B, eosin lake, Rhodamine Lake B, alizarin lake, Brilliant Carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, and C.I. Pigment Red 222.

Examples of the violet colorant include manganese violet, fast violet B, and methyl violet lake. Examples of the blue colorant include iron blue, cobalt blue, alkali blue lake, victoria blue lake, phthalocyanine blue, metal-free phthalocyanine blue, partially chlorinated phthalocyanine blue, Fast Sky Blue, Indanthrene Blue BC, C.I. Pigment Blue 15, C.I. Pigment Blue 15:2, C.I. Pigment Blue 15:3, C.I. Pigment Blue 16, and C.I. Pigment Blue 60.

Examples of the green colorant include chrome green, chromium oxide, Pigment Green B, mica light green lake, Final Yellow Green G, and C.I. Pigment Green 7.

In the toner of the present disclosure, one of the above colorants can be used individually, or two in combination, and the combination may have different colors or the same color.

In addition, two or more colorants may be used in the form of composite particles. The composite particles can be produced for example, by adding appropriate amounts of water, a lower alcohol, and/or the like to two or more colorants, granulating the mixture with a common granulator, such as a high-speed mill, and drying the granulated mixture. Furthermore, to uniformly disperse the colorant in the binder resin, the colorant may be used in the form of masterbatch. The composite particles and masterbatch are mixed into a toner composition during dry mixing.

The content of the colorant in the toner core particles of the present disclosure is not particularly limited but is preferably from 0.1 to 20 parts by mass and more preferably from 0.2 to 10 parts by mass per 100 parts by mass of the binder resin.

The colorant contained in the amount in the above range enables formation of an image with high image density and very good image quality without impairing various physical properties of the toner.

The content of the colorant in terms of that in the toner core particles is preferably from 2.5 to 7.5 mass % and more preferably from 3.0 to 6.5 mass %.

### (1-2-4) Charge Control Agent

For the charge control agent contained in the toner of the present disclosure, a charge control agent for negative charge control commonly used in the art can be used.

Examples of the charge control agent for negative charge control include oil-soluble dyes, such as oil black and Spiron Black; metal-containing azo compounds, azo complex dyes, metal salts of naphthenic acid, metal complexes and metal salts of salicylic acid and its derivatives (examples of the metal include chromium, zinc, or zirconium), boron compounds, fatty acid soaps, long-chain alkyl carboxylate salts, and resin acid soaps.

In the toner of the present disclosure, one of the above charge control agents can be used individually, or two or more in combination.

The content of the charge control agent in the toner core particles of the present disclosure is not particularly limited but is preferably from 0.5 to 3 parts by mass and more preferably from 1 to 2 parts by mass per 100 parts by mass of the binder resin.

The charge control agent contained in the amount in the above range enables formation of an image with high image density and very good image quality without impairing various physical properties of the toner.

The content of the charge control agent in terms of that in the toner core particles is preferably from 0.5 to 2.0 mass% and more preferably from 0.7 to 1.5 mass %.

### (2) Method for Producing Toner

A method for producing the toner of the present disclosure includes:
externally adding the external additive to the toner core particles by adding and mixing the external additive of the barium titanate particles to the toner core particles (first external addition); and
externally adding the external additive to the first externally added toner core particles by further adding and mixing the external additive of the small size silica particles to the first externally added toner core particles (second external addition).

In addition, a method for producing the toner further containing, as an external additive, large size silica particles with an average primary particle size of 70 to 200 nm includes:
externally adding the external additive to the toner core particles by adding and mixing the external additive of the barium titanate particles to the toner core particles (first external addition);
externally adding the external additive to the first externally added toner core particles by further adding and mixing the external additive of the small size silica particles to the first externally added toner core particles (second external addition); and
externally adding the external additive to the second externally added toner core particles by further adding and mixing the external additive of the large size silica particles to the second externally added toner core particles (third external addition).

### (2-1) First External Addition

In the first external addition, the external additive of the barium titanate particles is added to the toner core particles and mixed.

The operations of the addition and mixing can be carried out using a known device commonly used in the art, and conditions in the step are to be appropriately set according to the target material and desired physical properties.

### (2-2) Second External Addition

In the second eternal addition, the external additive of the small size silica particles is further added to the first externally added toner core particles and mixed.

As in the first external addition, the operations of the addition and mixing can be carried out using a known device commonly used in the art, and conditions in the step are to be appropriately set according to the target material and desired physical properties.

### (2-3) Third External Addition

In the third external addition, the external additive of the large size silica particles is further added to the second externally added toner core particles and mixed.

As in the first external addition, the operations of the addition and mixing can be carried out using a known device commonly used in the art, and conditions in the step are to be appropriately set according to the target material and desired physical properties.

### (2-4) Method for Producing Toner Core Particles

The toner core particles used in the present disclosure can be produced by a known method using a known device commonly used in the art. For example, the toner core particles can be produced by:
(a) mixing a coarsely pulverized melt-kneaded product containing at least a binder resin and a release agent with a filler;
(b) finely pulverizing the mixture obtained in step (a);
(c) classifying the finely pulverized product obtained in step (b); and
(d) spheronizing the classified product obtained in step (c) with hot air.

A dry process is preferred in that it requires fewer steps and lower equipment costs than a wet process, and among dry processes, a pulverization method is particularly preferred.

Conditions in each of the above steps are to be appropriately set according to the target material and desired physical properties.

### (3) Developer (Two-Component Developer)

A developer of the present disclosure contains the toner of the present disclosure and a carrier.

### Carrier

The toner of the present disclosure may be used in the form of either a one-component developer or a two-component developer and is further blended with a carrier in addition to the external additives when used as a two-component developer.

For the carrier, a carrier commonly used in the art can be used; examples include single or composite ferrites composed of iron, copper, zinc, nickel, cobalt, manganese, chromium, and/or the like, and carriers produced by surface-covering carrier core particles with a known covering material.

The average particle size of the carrier is preferably from 10 to 100 μm and greater preferably from 20 to 50 μm.

The blending amount of the carrier is not particularly limited but is preferably from 4 to 15 parts by mass and more preferably from 5 to 10 parts by mass per 100 parts by mass of the toner core particles.

### (4) Image Forming Device

An image forming device of the present disclosure is an image forming device that forms an image by forming an electrostatic latent image on a surface of an electrophotographic photoreceptor and transferring a toner developed on the electrostatic latent image to a transfer receiving material, in which the toner is the toner described above.

The image forming device of the present disclosure is not particularly limited as long as the image forming device includes the above-described components; examples include an image forming device including at least:
a photoreceptor,
a charger that charges the photoreceptor,
an exposurer that exposes the charged photoreceptor to form an electrostatic latent image,
a developing device that develops the electrostatic latent image formed by the exposure to form a toner image,
a transferer that transfers the toner image formed by development onto a recording medium,
a fixer that fixes the transferred toner image to the recording medium to form an image,
a cleaning device that removes and recovers the toner remaining on the photoreceptor, and
a discharger that discharges surface charge remaining on the photoreceptor.

Hereinafter, an example of the image forming device and its operation will be described based on a drawing, but the disclosure is not limited by these.

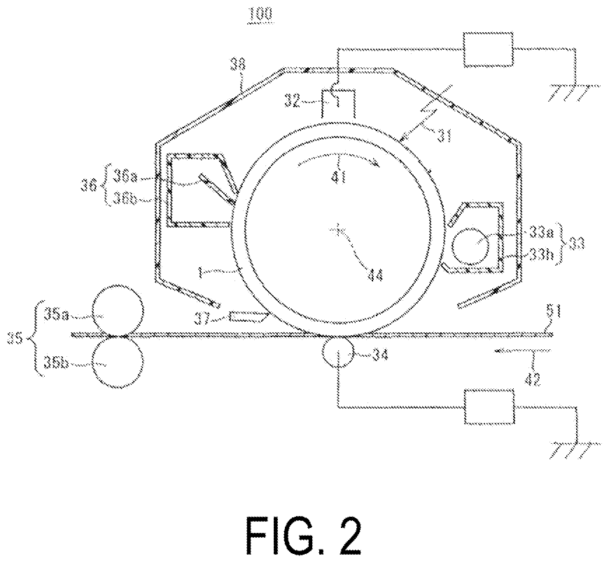

FIG. 2 is a schematic side view illustrating a configuration of a main portion of an image forming device 100 of the present disclosure.

The image forming device (laser printer) 100 of FIG. 2 includes a photoreceptor 1, an exposurer (semiconductor laser) 31, a charger (charging device) 32, a developing device 33, a transferer (transfer charger) 34, a conveyor belt (not illustrated), a fixer (fixing device) 35, and a cleaning device (cleaner) 36. Reference numeral 51 denotes a recording medium (recording paper or transfer paper).

The photoreceptor 1 is not particularly limited as long as it is used as a photoreceptor of an image forming device in the art; examples include a photoreceptor including at least a laminated photosensitive layer in which a charge generation layer containing a charge generation material and a charge transport layer containing a charge transport material are laminated in this order on a substrate, or a single-layer photosensitive layer containing a charge generation material and a charge transport material.

The photoreceptor 1 is rotatably supported on the main body of the image forming device 100 and is driven to rotate around a rotation axis 44 in the direction of arrow 41 with a driver not illustrated. The driver includes, for example, an electric motor and a reduction gear, and drives the photoreceptor 1 to rotate at a predetermined circumferential velocity by conveying the driving force to a conductive support constituting the core body of the photoreceptor 1. The charger (charging device) 32, the exposurer 31, the developing device 33, the transferer (transfer charger) 34, and the cleaning device (cleaner) 36 are provided in this order along the outer circumferential surface of the photoreceptor 1 from upstream to downstream in the direction of rotation of the photoreceptor 1 indicated by arrow 41.

The charging device 32 is a charger that uniformly charges the outer circumferential surface of the photoreceptor 1 to a predetermined potential.

Examples of the charger include a contactless charging system, such as a corona charging system with an electrification charger, and a contact charging system with a charging roller or a charging brush.

The exposurer 31 includes a semiconductor laser as a light source and exposes the charged outer circumferential surface of the photoreceptor 1 according to image information by irradiating the surface of the photoreceptor 1 between the charging device 32 and the developing device 33 with a laser beam emitted from the light source. The light is repeatedly scanned in the main scanning direction, the direction in which the rotation axis 44 of the photoreceptor 1 extends, and these are imaged to sequentially form electrostatic latent images on the surface of the photoreceptor 1. That is, the irradiation and non-irradiation of the laser beam cause a difference in the charge amount on the photoreceptor 1 uniformly charged by the charging device 32, and this forms an electrostatic latent image.

The developing device 33 is a developing device that develops an electrostatic latent image with a developer (toner), the electrostatic latent image formed on the surface of the photoreceptor 1 by exposure, and is provided to face the photoreceptor 1, and includes:
a developing roller 33a that supplies a toner to the outer circumferential surface of the photoreceptor 1; and
a casing 33b that rotatably supports the developing roller 33a around a rotation axis parallel to the rotation axis 44 of the photoreceptor 1 and that contains a developer containing toner in the internal space of the casing.

The transfer charger 34 is a transferer that transfers a toner image onto a transfer paper 51, the toner image being a visible image formed on the outer circumferential surface of the photoreceptor 1 by development, and the transfer paper 51 being a recording medium supplied between the photoreceptor 1 and the transfer charger 34 from the direction of arrow 42 by a conveyor not illustrated. The transfer charger 34 is, for example, a contact-type transferer including a charger and transferring the toner image onto the transfer paper 51 by applying, to the transfer paper 51, a charge with a polarity opposite from that of the toner.

The cleaner 36 is a cleaning device that removes and recovers the toner remaining on the outer circumferential surface of the photoreceptor 1 after the transfer operation by the transfer charger 34 and includes:
a cleaning blade 36a that scales the toner remaining on the outer circumferential surface of the photoreceptor 1, and
a recovery casing 36b that contains the toner scaled by the cleaning blade 36a. In addition, the cleaner 36 is provided together with a discharging lamp not illustrated.

Furthermore, the image forming device 100 is provided with the fixing device 35, which is a fixer that fixes the transferred image, on the downstream side to which the transfer paper 51 that has passed between the photoreceptor 1 and the transfer charger 34 is conveyed. The fixing device 35 includes a heating roller 35a including a heater not illustrated and a pressure roller 35b provided to face the heating roller 35a and to be pressed against the heating roller 35b to form a contact portion.

Reference numeral 37 denotes a separator that separates the transfer paper and the photoreceptor, and reference numeral 38 denotes a housing that contain the above devices of the image forming device.

The image forming operation with the image forming device 100 is performed as follows. First, when the photoreceptor 1 is driven to rotate in the direction of arrow 41 by the driver, the surface of the photoreceptor 1 is uniformly charged to a predetermined positive potential by the charger 32 provided upstream in the direction of rotation of the photoreceptor 1 from the image formation point of light by the exposurer 31.

Then, the surface of the photoreceptor 1 is irradiated with light corresponding to image information from the exposurer 32. This exposure removes the surface charge of the light-irradiated portion in the photoreceptor 1. This causes a difference between the surface potential of the light-irradiated portion and the surface potential of the non-light-irradiated portion and forms a latent image.

The toner is supplied from the developing device 33 provided downstream in the direction of rotation of the photoreceptor 1 from the image formation point of light by the exposurer 33 to the surface of the photoreceptor 1, on which the electrostatic latent image has been formed, and this develops an electrostatic latent image and forms a toner image.

The transfer paper 51 is supplied between the photoreceptor 1 and the transfer charger 34 in synchronization with the exposure of the photoreceptor 1. The transfer charger 34 applies an electric charge with a polarity opposite from that of the toner to the supplied transfer paper 51, and the toner image formed on the surface of the photoreceptor 1 is transferred onto the transfer paper 51.

The transfer paper 51 onto which the toner image has been transferred is conveyed to the fixing device 35 by the conveyor and is heated and pressed when passing through the contact portion between the heating roller 35a and the pressing roller 35b of the fixing device 35, and the toner image is fixed on the transfer paper 51 to form a solid image. The transfer paper 51 on which the image has been thus formed is ejected to the outside of the image forming device 100 by a conveyor.

On the other hand, the toner remaining on the surface of the photoreceptor 1 even after the transfer of the toner image by the transfer charger 34 is scaled from the surface of the photoreceptor 1 and recovered by the cleaner 36. The electric charge on the surface of the photoreceptor 1 from which the toner has been thus removed is removed by light from a discharging lamp, and the electrostatic latent image on the surface of the photoreceptor 1 disappears. Thereafter, the photoreceptor 1 is further driven to rotate, and a series of operations starting from charging is repeated again to continuously form an image.

The image forming device 100 described above is a monochrome image forming device (printer) but may be, for example, a color image forming device with an intermediate transfer system capable of forming a color image. Specifically, the image forming device may be a full-color image forming device with a configuration, what is called a tandem-type, in which a plurality of photoreceptors on each of which a toner image is formed is arranged in a predetermined direction (e.g., in the horizontal direction H or in the substantially horizontal direction H). In addition, the image forming device 100 may be another color image forming device, a copier, a multifunctional device, or a facsimile machine.

### EXAMPLES

The present disclosure will be specifically described below by production examples, examples, and comparative examples, but the disclosure is not limited to the following examples as long as the gist of the disclosure is not exceeded.

In production examples, examples, and comparative examples, physical property values were measured by the following methods.

### Average Primary Particle Size (μm) of Toner Core Particles

To 50 mL of an electrolytic solution (available from Beckman Coulter, K.K., trade name: ISOTON-II), 20 mg of a sample and 1 mL of a sodium alkyl ether sulfate are added. The mixture is treated by dispersion at a frequency of 20 kHz for 3 minutes using an ultrasonic disperser (available from As One Corporation, Desktop Dual Frequency Ultrasonic Cleaner, model: VS-D100), and a measurement sample is prepared. The resulting measurement sample is measured using a particle size distribution measuring device (available from Beckman Coulter, K.K., model: Multisizer 3) under conditions of an aperture size of 100 μm and the number of measurement particles of 50000 counts, and the average primary particle size (μm) is determined from the volumetric particle size distribution of the sample particles.

### Average Primary Particle Size (nm) of Each External Additive

Particles of an external additive are photographed using a scanning electron microscope (SEM) (available from Hitachi High-Technologies Corporation, model: S-4800), the particle sizes (major axes) of 100 particles of the external additive are randomly measured from the resulting image, and the average value of those is calculated as the average primary particle size.

### Viscosity of Toner Core Particles at 90° C.

A flow tester (available from Shimadzu Corporation, model: CFT-100C) is used and set to apply a load of 10 kgf/cm² (0.98 MPa) and extrude 1 g of a toner from a die (nozzle diameter of 1.0 mm, length of 1.0 mm), and the toner is heated from 80° C. to 120° C. at a temperature increase rate of 6° C./min to determine the melt viscosity (apparent viscosity in Pa·s).

### Coverage of External Additives

A toner with external additives is photographed with a scanning electron microscope (SEM) (available from Hitachi High-Technologies Corporation, model: S-4800). A model calculation in the projected area is performed using the average particle size D and specific gravity pt of the toner core particles, and the average particle size d and specific gravity pi of each external additive, and the coverage F by each external additive is determined using the following equation, where C is the number of parts of the external additive added.

$$F = \frac{\sqrt{3}}{2 π} * \frac{{ρ}_{t} D}{{ρ}_{t} d} * C$$

### Distribution Deviation Value of Barium Titanate

The toner is subjected to a qualitative and quantitative analysis with a scanning electron microscope (available from Hitachi, Ltd., model: S-4800+EDX), BF and BH are measured, and a distribution deviation value (BH/BF) of the barium titanate particles is determined. BF is an average value of proportions of elementary barium Ba in flat portions. BH is an average value of proportions of elementary barium Ba in depressed portions. In the qualitative and quantitative analysis, for 50 particles of the toner, two depressed portions, such as a step and a groove, and two flat portions with no depression on a surface of each of the 50 particles, 200 points in total are analyzed.

### Adhesion Strength of Barium Titanate

A toner is subjected to an adhesion strength test of an external additive according to the following procedure, and a toner after the external additive removal treatment is produced.
(1) To 40 mL of a poly(oxyethylene) octylphenyl ether aqueous solution (available from Rohm and Haas Company (now The Dow Chemical Company), product name: Triton (trade name)) with a concentration of 0.2 mass %, 2.0 g of a toner is added and stirred for 1 minute.
(2) The resulting aqueous solution is irradiated with an ultrasonic wave with an output of 40 μA for 4 minutes using an ultrasonic homogenizer (available from Nissei Co., Ltd., model: US-300T).
(3) Thereafter, the aqueous solution is allowed to stand for 3 hours, and the toner and released external additives are separated.
(4) After removing the supernatant, about 50 mL of pure water is added to the precipitate, and the mixture is stirred for 5 minutes.
(5) The mixture is suction-filtered using a membrane filter with a pore size of 1 μm (available from Advantec Co., Ltd.).
(6) The toner remaining on the membrane filter is vacuum-dried overnight, and a toner after the external additive removal treatment is produced.

The resulting toner after the external additive removal treatment and the toner before the external additive removal treatment are analyzed for an intensity of an elementary barium Ba in 1 g of the toner using an X-ray fluorescence spectrometer (available from Rigaku Corporation, model: ZSX Primus II), and an adhesion strength of barium titanate is determined as a ratio SA2/SB2×100 (%) of an intensity SA2 after the adhesion strength test of an external additive to an intensity SB2 before the adhesion strength test of an external additive.

### Mobility of Barium Titanate

In a stainless-steel container with a capacity of 500 mL, 50 g of a toner is placed and stirred at a rotation speed of 1700 rpm (circulating speed of a stirring blade tip of 40 m/s) for 180 seconds using a blender (available from Yamato Scientific Co., Ltd., model: Small Blender MODEL 31BL42). An adhesion strength FB of barium titanate of the resulting content and an adhesion strength FA of barium titanate of the toner before stirring are measured, and a mobility (FB/FA)×100 (%) of the barium titanate particles is determined.

### Production Example 1: Preparation of Amorphous Polyester-Based Resin

In a reaction vessel with a capacity of 5 L, 440 g (2.7 mol) of terephthalic acid, 235 g (1.4 mol) of isophthalic acid, 7 g (0.05 mol) of adipic acid, 554 g (8.9 mol) of ethylene glycol, and 0.5 g of tetrabutoxytitanate as a polymerization catalyst were placed, and the mixture was reacted at 210° C. under a nitrogen stream for 5 hours while generated water and ethylene glycol were distilled off. Thereafter, the mixture was reacted under a reduced pressure of 5 to 20 mm Hg for 1 hour. Then, 103 g (0.54 mol) of trimellitic anhydride was added, and the mixture was reacted under normal pressure for 1 hour. The mixture was then reacted under reduced pressure of 20 to 40 mm Hg, and a resin was taken out at a predetermined softening point. The recovered ethylene glycol was 219 g (3.5 mol). The resulting resin was cooled to room temperature and then pulverized into particles, and the particles were used as amorphous polyester resin A.

The amorphous polyester-based resin had a glass transition temperature (Tg) of 56° C., a melting temperature (Tm) of 135° C., a peak top molecular weight (Mp) of 5000, a solubility parameter (SP) value of 11.0, an acid value of 37 mg KOH/g, and a hydroxyl value of 50 mg KOH/g.

### Production Example 2: Preparation of Crystalline Polyester-Based Resin

In a reaction vessel with a capacity of 5 L, 132 g (1.12 mol) of 1,6-hexanediol, 230 g (1.0 mol) of 1,10-decanedicarboxylic acid, and 3 g of tetrabutoxytitanate as a polymerization catalyst were placed, and the mixture was reacted at 210° C. under normal pressure for 5 hours while generated water was distilled off. Thereafter, the reaction was continued under a reduced pressure of 5 to 20 mm Hg, and a resin was taken out when the acid value became 2 mg KOH/g or less. The resulting resin was cooled to room temperature and then pulverized into particles, and the particles were used as crystalline polyester resin C.

The crystalline polyester-based resin had a melting point (Tmp) of 80° C., a Tm of 88° C., a Tm/Tmp of 1.1, a peak top molecular weight (Mp) of 30000, an SP value of 9.5, an acid value of 1 mg KOH/g, and a hydroxyl value of 10 mg KOH/g.

### Production Example 3: Production of Toner Core Particles C

Toner core particles C used in examples were prepared as follows using the following materials.

Binder resin: the amorphous polyester-based resin (Production Example 1) 62 mass % the crystalline polyester-based resin (Production Example 2) 25 mass %

Colorant: C.I. Pigment Blue 15:3 (available from DIC Corporation) 7 mass% Release agent: a monoester-based wax (available from NOF Corporation, product name: WEP-3) 5 mass %

Charge control agent: a salicylic acid compound (available from Orient Chemical Industries Co., Ltd., product name: Bontron E-84) 1 mass %

The above materials were premixed for 5 minutes using an air flow mixer (Henschel mixer, available from Mitsui Mining Co., Ltd. (now Nippon Coke & Engineering Co., Ltd.), model: FM20C) [mixing] and then melt-kneaded using an open roll type continuous kneader (available from Mitsui Mining Co., Ltd. (now Nippon Coke & Engineering Co., Ltd.), model: MOS320-1800), and a melt-kneaded product was produced [kneading]. The setting conditions of the open rolls were as follows: a supply side temperature of the heating roll of 130° C., a discharge side temperature of the heating roll of 100° C., a supply side temperature of the cooling roll of 40° C., and a discharge side temperature of the cooling roll of 25° C. Rolls with a diameter of 320 mm and an effective length of 1550 mm were used as the heating roll and the cooling roll, and the gaps between the rolls on the supply side and the discharge side were both set at 0.3 mm. In addition, the rotation speed of the heating roll was set at 75 rpm, that of the cooling roll at 65 rpm, and the supply amount of the toner raw material was set at 5.0 kg/h.

The resulting melt-kneaded product was cooled with a cooling belt and then coarsely pulverized using a speed mill with a φ2 mm screen, and a coarsely pulverized product was produced [coarse pulverization].

The resulting coarsely pulverized product was finely pulverized using a jet pulverizer (available from Nippon Pneumatic Mfg. Co., Ltd., model: IDS-2), and a finely pulverized product was produced [fine pulverization].

The resulting finely pulverized product was then classified using an elbow jet classifier (available from Nittetsu Mining Co., Ltd., model: EJ-LABO), and toner core particles A with an average primary particle size of 6.0 μm were produced [classification].

### Production Example 4: Production of Toner Core Particles A

Toner core particles A used in comparative examples (reference examples) were prepared in the same manner as in Production Example 3 except that the crystalline polyester-based resin was not used and 87 mass % of the amorphous polyester-based resin was used.

### Production Example 5: Production of Toner Core Particles B

Toner core particles B used in comparative examples (reference examples) were prepared in the same manner as in Production Example 3 except that the mass percent of the crystalline polyester-based resin was changed from 25 mass % to 20 mass %, and the mass percent of the amorphous polyester-based resin was changed from 62 mass % to 67 mass %.

### Production Example 6: Production of Toner Core Particles D

Toner core particles D used in examples were prepared in the same manner as in Production Example 3 except that the mass percent of the crystalline polyester-based resin was changed from mass % to 27 mass %, and the mass percent of the amorphous polyester-based resin was changed from 62 mass % to 60 mass %.

### Production Example 7: Production of Toner Core Particles E

Toner core particles E used in comparative examples were prepared in the same manner as in Production Example 3 except that the mass percent of the crystalline polyester-based resin was changed from 25 mass % to 30 mass %, and the mass percent of the amorphous polyester-based resin was changed from 62 mass % to 57 mass %.

### Production Examples 8 to 13: Preparation of Barium Titanate Particles A to F

Barium titanate powders (available from Toda Kogyo Corp., product grade T-BTO-030RF (average primary particle size 43 nm) and product grade T-BTO-050RF (average primary particle size 54 nm)) were used.

The barium titanate powder in an amount of 50 g was mixed by stirring in 250 g of isopropyl alcohol and dispersed, and a slurry was produced.

To the resulting slurry, 540 g of zirconia beads with a diameter of 0.3 mm were added and mixed by stirring, and pulverized with a bead mill for 1 hour. The zirconia beads were separated from the pulverized product, and the separated slurry was dried at 150° C. for 4 hours. The resulting dried product was passed through a collision pulverizer to loosen the aggregation, and a barium titanate powder with an average primary particle size smaller than that before the pulverization.

The pulverized barium titanate powder was observed with an SEM to observe how the average primary particle size decreased. The decrease in the average primary particle size was determined by measuring the major axes of the barium titanate particles and calculating the average value from the major axes of freely selected 100 particles.

Three types of barium titanate powders with different average primary particle sizes, including the original powder before pulverization, were prepared by repeating the above pulverization twice. The raw material barium titanate powders T-BTO-030RF and T-BTO-050RF were each subjected to the above pulverization, and a total of six types of barium titanate powders with different average primary particle sizes were prepared.

Two types of barium titanate powders with different average primary particle sizes were selected from the resulting six types of powders and uniformly mixed by adjusting the mixing ratio, and substrates of barium titanate A to F with an average primary particle size of 15 to 45 nm used in examples and comparative examples.

These substrates of barium titanate were surface-treated by a known method; barium titanate powders A to E with trifluoropropyltrimethoxysilane and barium titanate powder F with dimethylsiloxane.

Average particle size
Barium titanate A: 15 nm
Barium titanate B: 20 nm
Barium titanate C: 30 nm
Barium titanate D: 40 nm
Barium titanate E: 45 nm
Barium titanate F: 30 nm

### Production Example 14: Preparation of Carrier

To 100 parts by mass of a silicone resin, 10 parts by mass of PTFE (available from Daikin Industries, Ltd., product name: LDE-410) was added as fluorocarbon resin fine particles to prepare a resin solution. A carrier core material was immersed in this resin solution, and a carrier “SC-1” was produced.

### Example 1

### External Addition Treatment

The resulting toner core particles C in an amount of 100 parts by mass and 0.84 parts by mass (corresponding to a coverage of 7% for the toner core particles) of the barium titanate particles C (average primary particle size 30 nm) were placed in an FM mixer (available from Nippon Coke & Engineering Co., Ltd., model: FM-20) and mixed at a rotation speed of 3500 rpm for 90 seconds (first external addition).

Then, silica particles (average primary particle size 12 nm, hydrophobized with hexamethyldisilazane, available from WACKER, product name: H2000T) in an amount of 1.4 parts by mass (corresponding to a coverage of 88% for the toner core particles) were added as hydrophobized small size silica particles and mixed at a rotation speed of 3500 rpm for 90 seconds (second external addition).

The resulting mixture was sieved using a 270-mesh sieve, and a toner with external additives was produced.

### Preparation of Developer

The resulting toner with external additives and the carrier produced in Production Example 9 were placed in a V-shaped mixer (available from Tokuju Corporation, trade name: V-5) to give a toner concentration of 7 mass % and mixed for 20 minutes, and a two-component developer of Example 1 was produced.

### Example 2

A two-component developer of Example 2 was produced in the same manner as in Example 1 except that the parts by mass of the barium titanate particles C (average primary particle size 30 nm) were changed from 0.84 parts by mass (corresponding to a coverage of 7% for the toner core particles) to 0.24 parts by mass (corresponding to a coverage of 2% for the toner core particles) in the first external addition.

### Example 3

A two-component developer of Example 3 was produced in the same manner as in Example 1 except that 0.84 parts by mass (corresponding to a coverage of 7% for the toner core particles) of the barium titanate particles C (average primary particle size 30 nm) were changed to 0.16 parts by mass (corresponding to a coverage of 2% for the toner core particles) of the barium titanate particles B (average primary particle size 20 nm) in the first external addition.

### Example 4

A two-component developer of Example 4 was produced in the same manner as in Example 1 except that 0.84 parts by mass (corresponding to a coverage of 7% for the toner core particles) of the barium titanate particles C (average primary particle size 30 nm) were changed to 0.31 parts by mass (corresponding to a coverage of 2% for the toner core particles) of the barium titanate particles D (average primary particle size 40 nm) in the first external addition.

### Example 5

A two-component developer of Example 5 was produced in the same manner as in Example 1 except that 0.84 parts by mass (corresponding to a coverage of 7% for the toner core particles) of the barium titanate particles C (average primary particle size 30 nm) were changed to 0.24 parts by mass (corresponding to a coverage of 2% for the toner core particles) of the barium titanate particles F (average primary particle size 30 nm) in the first external addition.

### Example 6

A two-component developer of Example 6 was produced in the same manner as in Example 1 except that the mass percent of the barium titanate particles C (average primary particle size 30 nm) were changed from 0.84 parts by mass (corresponding to a coverage of 7% for the toner core particles) to 0.24 parts by mass (corresponding to a coverage of 2% for the toner core particles) in the first external addition, and after the second external addition, 1.0 parts by mass (corresponding to a coverage of 8% for the toner core particles) of silica particles (average primary particle size 110 nm, available from Shin-Etsu Chemical Co., Ltd., product name: X-24-9163A) were added and mixed at a rotation speed of 3500 rpm for 60 seconds (third external addition).

### Example 7

A two-component developer of Example 7 was produced in the same manner as in Example 1 except that the toner core particles C were changed to the toner core particles D, and 0.24 parts by mass (corresponding to a coverage of 2% for the toner core particles) of the barium titanate particles C (average primary particle size 30 nm) was used in the first external addition.

### Example 8

A two-component developer of Example 8 was produced in the same manner as in Example 1 except that 4.7 parts by mass (corresponding to a coverage of 88% for the toner core particles) of silica particles (average primary particle size 40 nm, hydrophobized with hexamethyldisilazane, available from Aerosil, product name: RX50) was used as hydrophobized small size silica particles instead of 1.4 parts by mass (corresponding to a coverage of 88% for the toner core particles) of the silica particles (average primary particle size 12 nm, hydrophobized with hexamethyldisilazane, available from WACKER, product name: H2000T) in the second external addition.

### Example 9

A two-component developer of Example 9 was produced in the same manner as in Example 1 except that the order of the first external addition and the second external addition was changed in the external addition treatment, and the small size silica particles were externally added in the first external addition, and the barium titanate particles were externally added in the second external addition.

### Comparative Example 1: Reference Example

A two-component developer of Comparative Example 1 was produced in the same manner as in Example 1 except that the toner core particles A were used instead of the toner core particles C, 1.52 parts by mass (corresponding to a coverage of 20% for the toner core particles) of aluminum oxide particles (average primary particle size 30 nm) were used instead of the barium titanate particles C per 100 parts by mass of the toner core particles in the first external addition, and 1.1 parts by mass (corresponding to a coverage of 70% for the toner core particles) of silica particles (average primary particle size 12 nm, hydrophobized with hexamethyldisilazane, available from WACKER, product name: H2000T) were used in the second external addition.

### Comparative Example 2: Reference Example

A two-component developer of Comparative Example 2 was produced in the same manner as in Example 1 except that the toner core particles B were used instead of the toner core particles C, 1.53 parts by mass (corresponding to a coverage of 15% for the toner core particles) of strontium titanate particles (average primary particle size 30 nm) were used instead of the barium titanate particles C per 100 parts by mass of the toner core particles in the first external addition, and 1.1 parts by mass (corresponding to a coverage of 70% for the toner core particles) of silica particles (average primary particle size 12 nm, hydrophobized with hexamethyldisilazane, available from WACKER, product name: H2000T) were used in the second external addition.

### Comparative Examples 3 to 5

Two-component developers of Comparative Examples 3 to 5 were produced in the same manner as in Example 1 except that 1.90 parts by mass, 1.52 parts by mass, and 1.14 parts by mass (corresponding to coverages of 25%, 20%, and 15% for the toner core particles respectively) of aluminum oxide particles (alumina, average primary particle size 30 nm) were used respectively instead of the barium titanate particles C per 100 parts by mass of the toner core particles in the first external addition, and 1.1 parts by mass (corresponding to a coverage of 70% for the toner core particles) of silica particles (average primary particle size 12 nm, hydrophobized with hexamethyldisilazane, available from WACKER, product name: H2000T) were used in the second external addition.

### Comparative Examples 6 to 8

Two-component developers of Comparative Examples 6 to 8 were produced in the same manner as in Example 1 except that 1.84 parts by mass, 1.53 parts by mass, and 1.22 parts by mass (corresponding to coverages of 18%, 15%, and 12% for the toner core particles respectively) of strontium titanate particles (average primary particle size 30 nm) were used respectively instead of the barium titanate particles C per 100 parts by mass of the toner core particles in the first external addition, and 1.1 parts by mass (corresponding to a coverage of 70% for the toner core particles) of silica particles (average primary particle size 12 nm, hydrophobized with hexamethyldisilazane, available from WACKER, product name: H2000T) were used in the second external addition.

### Comparative Examples 9 and 10

Two-component developers of Comparative Examples 9 and 10 were produced in the same manner as in Example 1 except that the parts by mass of the barium titanate particles C (average primary particle size 30 nm) were changed from 1.2 parts by mass (corresponding to a coverage of 7% for the toner core particles) to 1.37 parts by mass and 0.17 parts by mass respectively (corresponding to coverages of 8% and 1% for the toner core particles respectively) in the first external addition.

### Comparative Examples 11 and 12

Two-component developers of Comparative Examples 11 and 12 were produced in the same manner as in Example 1 except that instead of 0.84 parts by mass (corresponding to a coverage of 7% for the toner core particles) of the barium titanate particles C (average primary particle size 30 nm), 0.12 parts by mass (corresponding to a coverage of 2% for the toner core particles) of the barium titanate particles A (average primary particle size 15 nm) and 0.36 parts by mass (corresponding to a coverage of 2% for the toner core particles) of barium titanate particles E (average primary particle size 45 nm) were used, respectively in the first external addition.

### Comparative Example 13

A two-component developer of Comparative Example 13 was produced in the same manner as in Example 1 except that the toner core particles C were changed to the toner core particles E in the external addition treatment.

### Evaluations

A printing test was performed on the two-component developers prepared in Examples 1 to 9 and Comparative Examples 1 to 13 using an evaluation machine produced by modifying a digital copier (available from Sharp Corporation, model: BP-20C25). The remaining amount of the charge control agent (barium titanate) after the test was measured, and the ID value and the fog value before and after the test were measured and evaluated.

In the printing test, the evaluation machine was operated in three types of environments with a temperature of 25° C. and a humidity of 5% RH, a temperature of 25° C. and a humidity of 50% RH, and a temperature of 25° C. and a humidity of 80% RH in an environmental test room, and an image in which a region corresponding to 10% of the printable area of A4 paper was covered with a cyan toner was printed on 90000 sheets.

### Remaining Amount of Charge Control Agent

A calibration curve to determine the remaining amount of the charge control agent was prepared by the following procedure, and the remaining amount of the charge control agent (proportion of the embedded external additives of the developer in the final stage of the product life) was determined.
(1) Toners with external additives are prepared with four formulations to have external addition amounts 1 time, 0.75 times, 0.5 times, and 0.25 times the external addition amounts of the external additives of the toners (toners with external additives) of examples and comparative examples when the external addition amounts of the external additives of examples and comparative examples are each regarded as 1.
(2) Each of the resulting toners with external additives with four formulations and the carrier “SC-1” prepared in Production Example 9 are placed in a V-shaped mixer (available from Tokuju Corporation, trade name: V-5) in the same manner as in “preparation of developer” of Example 1 to give a toner concentration of 7 mass % and mixed for 20 minutes, and a two-component developer is produced.
(3) In a 25-mL glass container with a lid, 10 g of the developer is placed, and the glass container is allowed to stand with the lid open in an environment with a temperature of 25° C. and a humidity of 50% for 12 hours. Then, the lid of the glass container is closed, and the developer is stirred under conditions of a shaking frequency of 25.4 Hz and a shaking time of 60 seconds using a shaker (available from Retsch, model: Mixer Mill MM200). Thereafter, the charge amount is measured using a suction-type charge amount measuring device (available from TREK, Inc., model: 210HS-2A).
(4) The measured values of the charge amounts of the toners with external additives with four formulations are graphed, and a straight line connecting the points is used as a calibration curve.
(5) The charge amount of the developer after the printing test is measured in the same manner as in the operation (3) above and compared with the calibration curve to calculate the remaining amount of the charge control agent (proportion of the embedded external additives of the developer in the final stage of the product life).

### ID Value

An image in which a region corresponding to 10% of the printable area of A4 paper was covered with a cyan toner was printed using the evaluation machine in a low humidity environment (a temperature of 25° C. and a humidity of 5% RH), a standard environment (a temperature of 25° C. and a humidity of 50% RH), and a high humidity environment (a temperature of 25° C. and a humidity of 85% RH). The density at a specific place (a band about 2 cm wide covered in the longitudinal direction of the A4 paper, average of five points in the central portion) was measured using a densitometer (available from Videoj et X-Rite K.K., model: spectrocolorimeter/densitometer X-Rite eXact).

Assessment was made according to the following criteria from the relationship between the resulting measured value and a specified value of the ID value (specified value determined by the evaluation machine and the evaluation content).

Excellent: the measured value was 100% or greater relative to the specified value of the ID value

Good: the measured value was 90% or greater and less than 100% relative to the specified value of the ID value

Marginal: the measured value was 80% or greater and less than 90% relative to the specified value of the ID value

Poor: the measured value was less than 80% relative to the specified value of the ID value

### Fog Value

An image in which a region corresponding to 10% of the printable area of A4 paper was covered with a cyan toner was printed using the evaluation machine in a low humidity environment (a temperature of 25° C. and a humidity of 5% RH), a standard environment (a temperature of 25° C. and a humidity of 50% RH), and a high humidity environment (a temperature of 25° C. and a humidity of 85% RH). The brightness of a specific place not covered was measured using a colorimetric color difference meter (available from Nippon Denshoku Industries Co., Ltd., model: ZE6000).

The difference between the brightness before printing measured in advance and the measured value was defined as a fog value and assessed according to the following criteria.

Excellent: the measured value was 80% or less relative to the specified value of the fog value

Good: the measured value was 80% or greater and 90% or less relative to the specified value of the fog value

Marginal: the measured value was 90% or greater and 100% or less relative to the specified value of the fog value

Poor: the measured value was greater than 100% relative to the specified value of the fog value

### Combined Assessment of ID Value and Fog Value

Assessment was made according to the following criteria from the measurement results of the ID value and the measurement results of the fog value in the low humidity environment and in the high humidity environment.

Excellent: both the ID value and the fog value in the low humidity environment and in the high humidity environment were assessed as excellent

Good: either the ID value or the fog value in the low humidity environment and in the high humidity environment was assessed as good or better

Marginal: either the ID value or the fog value in the low humidity environment and in the high humidity environment was assessed as marginal or better

Poor: either the ID value or the fog value in the low humidity environment and in the high humidity environment was assessed as poor or better

### Comprehensive Assessment of Image Quality

Comprehensive assessment was made according to the following criteria from the assessment results of the ID value and the fog value of the developer in the initial state (Tables 1 and 2) and the assessment results of the ID value and the fog value of the developer in the worn and deteriorated state (in the final stage of life).

Excellent: the assessment results of the ID value and the fog value were excellent from the initial state to the worn and deteriorated state

Good: the combined assessment result of the ID value and the fog value was good in either the initial state or the worn and deteriorated state

Marginal: the combined assessment result of the ID value and the fog value was marginal in either the initial state or the worn and deteriorated state

Poor: the combined assessment result of the ID value and the fog value was poor in either the initial state or the worn and deteriorated state

The constituent materials of the toners of the examples and their physical properties are shown in Table 1, the constituent materials of the toners of the comparative examples and their physical properties are shown in Table 2, and the evaluation results are shown in Table 3.

In Tables 1 and 2, A to E in the material type of the toner core particles mean toner core particles A to E, the charge control agents TB-A to TB-F mean barium titanate particles A to F, AL means the alumina particles, and TS means the strontium titanate particles.

In addition, in Tables 1 and 2, “good” in PS<PB means that the average primary particle size PS of the small size silica particles and the average primary particle size PB of the barium titanate particles satisfy the above relationship.

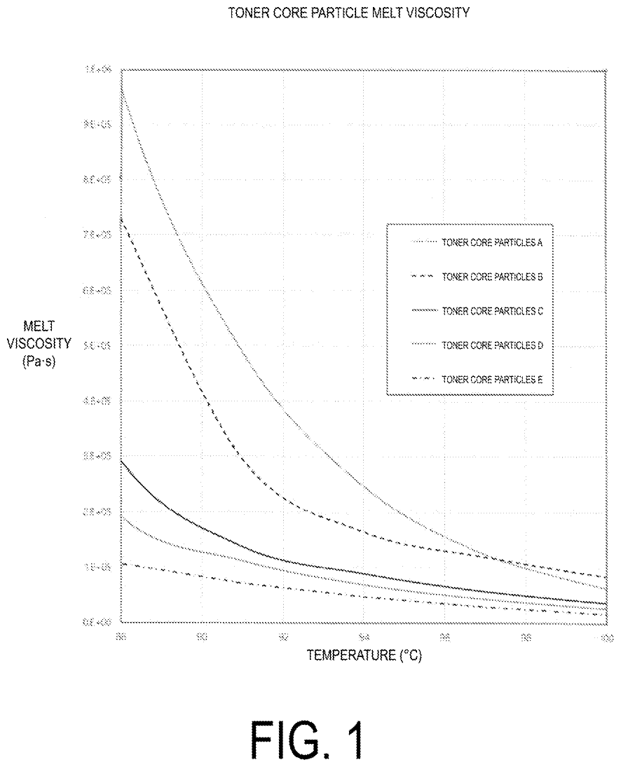

The relationship between the temperature and the melt viscosity of the toner core particles is shown in FIG. 1. FIG. 1 shows that toner core particles C and D satisfy the requirement of the present disclosure.

TABLE 1

| | | | | External additives | | | | | | | | | |
|---|---|---|---|---|---|---|---|---|---|---|---|---|---|
| | Toner core particles | | | Charge control agent | | | | | | Silica particles | | | |
| | | | BET | | Average | | | | | Average | | | |
| | | | specific | | primary | | Adhesion of barium titanate | | | primary | | | |
| | | Viscosity | surface | | particle | | | Adhesion | | particle | Cov- | | ID value |
| | Material | at 90 C. | area | Material | size PB | Coverage | Deviation | strength | | size PS | erage | PS < | fog value |
| | type | (Pa · s) | (m2/g) | type | (nm) | (%) | value | (%) | Mobility | (nm) | (%) | PB | assessment |
| Example 1 | C | 177600 | 2.2 | TB-C | 30 | 7 | 2.1 | 82 | 1.0 | 12 | 88 | Good | Excellent |
| Example 2 | C | 177600 | 2.2 | TB-C | 30 | 2 | 2.1 | 82 | 1.0 | 12 | 88 | Good | Excellent |
| Example 3 | C | 177600 | 2.2 | TB-B | 20 | 2 | 2.0 | 83 | 1.1 | 12 | 88 | Good | Excellent |
| Example 4 | C | 177600 | 2.2 | TB-D | 40 | 2 | 2.1 | 82 | 1.0 | 12 | 88 | Good | Good |
| Example 5 | C | 177600 | 2.2 | TB-F | 30 | 2 | 1.8 | 82 | 1.2 | 12 | 88 | Good | Excellent |
| Example 6 | C | 177600 | 2.2 | TB-C | 30 | 2 | 2.1 | 90 | 0.8 | 12/110* | 88 | Good | Excellent |
| Example 7 | D | 137600 | 2.3 | TB-C | 30 | 2 | 2.0 | 85 | 0.9 | 12 | 88 | Good | Excellent |
| Example 8 | C | 177600 | 2.2 | TB-C | 30 | 2 | 1.6 | 70 | 1.2 | 40 | 88 | Poor | Excellent |
| Example 9 | C | 177600 | 2.2 | TB-C | 30 | 2 | 1.5 | 65 | 1.4 | 12 | 88 | Good | Excellent |

*means the average primary particle size of the silica particles in the second external addition/the average primary particle size of the silica particles in the third external addition.

TABLE 2

| | | | | External additives | | | | | | | | | |
|---|---|---|---|---|---|---|---|---|---|---|---|---|---|
| | Toner core particles | | | Charge control agent | | | | | | Silica particles | | | |
| | | | BET | | Average | | | | | Average | | | |
| | | | specific | | primary | | Adhesion of barium titanate | | | primary | | | |
| | | Viscosity | surface | | particle | | | Adhesion | | particle | Cov- | | ID value |
| | Material | at 90 C. | area | Material | size PB | Coverage | Deviation | strength | | size PS | erage | PS < | fog value |
| | type | (Pa · s) | (m2/g) | type | (nm) | (%) | value | (%) | Mobility | (nm) | (%) | PB | assessment |
| Comparative | A | 627800 | 1.9 | AL | 30 | 20 | — | — | — | 12 | 70 | — | Excellent |
| Example 1 | | | | | | | | | | | | | |
| Comparative | B | 424900 | 2.0 | TS | 30 | 15 | — | — | — | 12 | 70 | — | Excellent |
| Example 2 | | | | | | | | | | | | | |
| Comparative | C | 177600 | 2.2 | AL | 30 | 25 | — | — | — | 12 | 70 | — | Poor |
| Example 3 | | | | | | | | | | | | | |
| Comparative | C | 177600 | 2.2 | AL | 30 | 20 | — | — | — | 12 | 70 | — | Excellent |
| Example 4 | | | | | | | | | | | | | |
| Comparative | C | 177600 | 2.2 | AL | 30 | 15 | — | — | — | 12 | 70 | — | Excellent |
| Example 5 | | | | | | | | | | | | | |
| Comparative | C | 177600 | 2.2 | TS | 30 | 18 | — | — | — | 12 | 70 | — | Poor |
| Example 6 | | | | | | | | | | | | | |
| Comparative | C | 177600 | 2.2 | TS | 30 | 15 | — | — | — | 12 | 70 | — | Excellent |
| Example 7 | | | | | | | | | | | | | |
| Comparative | C | 177600 | 2.2 | TS | 30 | 12 | — | — | — | 12 | 70 | — | Excellent |
| Example 8 | | | | | | | | | | | | | |
| Comparative | C | 177600 | 2.2 | TB-C | 30 | 8 | 2.1 | 82 | 1.0 | 12 | 88 | Good | Poor |
| Example 9 | | | | | | | | | | | | | |
| Comparative | C | 177600 | 2.2 | TB-C | 30 | 1 | 2.1 | 82 | 1.0 | 12 | 88 | Good | Good |
| Example 10 | | | | | | | | | | | | | |
| Comparative | C | 177600 | 2.2 | TB-A | 15 | 2 | 1.7 | 88 | 1.2 | 12 | 88 | Good | Excellent |
| Example 11 | | | | | | | | | | | | | |
| Comparative | C | 177600 | 2.2 | TB-E | 45 | 2 | 2.0 | 80 | 1.0 | 12 | 88 | Good | Poor |
| Example 12 | | | | | | | | | | | | | |
| Comparative | E | 81500 | 2.4 | TB-C | 30 | 2 | 2.1 | 90 | 0.7 | 12 | 88 | Good | Excellent |
| Example 13 | | | | | | | | | | | | | |

TABLE 3

| | Developer in life final stage | | | | |
|---|---|---|---|---|---|
| | Charge control agent | | | ID | |
| | Remaining | Required | Remaining | value fog | Compre- |
| | coverage | lower limit | amount | value | hensive |
| | (%) | coverage | assessment | assessment | assessment |
| Example 1 | 5.0 | 1.0 | Good | Good | Good |
| Example 2 | 1.3 | 1.0 | Good | Good | Good |
| Example 3 | 1.0 | 1.0 | Marginal | Marginal | Marginal |
| Example 4 | 1.1 | 1.0 | Good | Marginal | Marginal |
| Example 5 | 1.0 | 1.0 | Marginal | Marginal | Marginal |
| Example 6 | 1.4 | 1.0 | Excellent | Excellent | Excellent |
| Example 7 | 1.2 | 1.0 | Good | Good | Good |
| Example 8 | 1.0 | 1.0 | Marginal | Marginal | Marginal |
| Example 9 | 1.0 | 1.0 | Marginal | Marginal | Marginal |
| Comparative | 16 | 15 | Excellent | Good | Not |
| Example 1 | | | | | applicable |
| Comparative | 12 | 10 | Excellent | Good | Not |
| Example 2 | | | | | applicable |
| Comparative | 15 | 15 | Good | Good | Poor |
| Example 3 | | | | | |
| Comparative | 12 | 15 | Poor | Poor | Poor |
| Example 4 | | | | | |
| Comparative | 9 | 15 | Poor | Poor | Poor |
| Example 5 | | | | | |
| Comparative | 11 | 12 | Poor | Poor | Poor |
| Example 6 | | | | | |
| Comparative | 9 | 12 | Poor | Poor | Poor |
| Example 7 | | | | | |
| Comparative | 7 | 12 | Poor | Poor | Poor |
| Example 8 | | | | | |
| Comparative | 5 | 1.0 | Excellent | Good | Poor |
| Example 9 | | | | | |
| Comparative | 0.7 | 1.0 | Poor | Poor | Poor |
| Example 10 | | | | | |
| Comparative | 0.9 | 1.0 | Poor | Poor | Poor |
| Example 11 | | | | | |
| Comparative | 1.1 | 1.0 | Good | Poor | Poor |
| Example 12 | | | | | |
| Comparative | 0.8 | 1.0 | Poor | Poor | Poor |
| Example 13 | | | | | |

Tables 1 to 3 reveal the following.
(1) The developer containing the toner of the present disclosure maintained high image quality in both the low humidity environment and the high humidity environment from the initial stage to the final stage of the product life (life), had low-temperature fixability and excellent heat-resistant storage stability, controlled charge reduction of the developer due to development stress, and was able to maintain high image quality throughout the product life (Examples 1 to 9).
(2) The reduction of the average primary particle size of the barium titanate particles from 30 nm to 20 nm made the barium titanate particles slightly difficult to be flowed into the depressions on the toner surfaces, and in the final stage of the product life, the barium titanate particles embedded to the same extent as the remaining required amount, but this did not affect image quality (Example 3).
(3) The increase of the average primary particle size of the barium titanate particles from 30 nm to nm slightly reduced the surface area of barium titanate relative to the covered area and slightly reduced the capability of improving the environmental charging performance but did not affect image quality (Example 4).
(4) The change of the surface treatment agent for hydrophobization treatment of the barium titanate particles from trifluoropropyltrimethoxysilane to dimethylsiloxane made the barium titanate particles difficult to be flowed into the depressions on the toner surfaces, and in the final
stage of the product life, the barium titanate particles embedded to the same extent as the remaining required amount, and this did not affect image quality (Example 5).
(5) The external addition of the large size silica particles with an average primary particle size of 110 nm in the third external addition allowed high image quality to be maintained in both the low humidity environment and the high humidity environment from the initial stage to the final stage of the product life, the barium titanate particles to sufficiently remain also in the final stage of the product life, and the environmental charging performance to be maintained (Example 6).
(6) Also with the toner core particles with a low viscosity at 90° C., the remaining amount of barium titanate was greater than the required lower limit, and high image quality was maintained in both the low humidity environment and the high humidity environment from the initial stage to the final stage of the product life (Example 7).
(7) With the silica particles of the second external addition with an average primary particle size of nm, which were larger than the barium titanate particles with an average primary particle size of 30 nm, the barium titanate particles embedded to the same level as the remaining required amount and a slight decrease in ID was found in the final stage of the product life, but these had little effect on image quality (Example 8).
(8) The external addition of the small size silica particles in the first external addition and the barium titanate particles in the second external addition caused insufficient flow of the barium titanate particles into the depressions of the toner surfaces, and the barium titanate particles embedded to the same level as the remaining required amount and a slight decrease in ID was found in the final stage of the product life, but these had little effect on image quality (Example 9).
(9) For the known toners using the toner core particles with a viscosity at 90° C. of greater than 250000 Pa·s, the external addition of the alumina particles at a coverage of 20% and the strontium titanate particles at a coverage of 15% as external additives maintained the environmental charging performance from the initial stage to the final stage of the product life (Comparative Examples 1 and 2: reference examples).
(10) For the known toners using the toner core particles with a viscosity at 90° C. of 250000 Pa·s or less, the remaining amount of alumina greatly decreased in the final stage of the product life, and with the excessive external addition amount of the alumina particles, fog occurred in the high humidity environment in the initial stage (Comparative Example 3), in addition, the remaining amount of alumina fell below the lower limit, and an ID decrease occurred in the low humidity environment (Comparative Example 4), and an ID decrease and white spots occurred in the low humidity environment (Comparative Example 5).
(11) For the known toners using the toner core particles with a viscosity at 90° C. of 250000 Pa·s or less, with the strontium titanate particles externally added as the external additive with a coverage of 18%, 15%, or 12%, the remaining amount of strontium titanate greatly decreased and fell below the lower limit in the final stage of the product life, and an ID decrease occurred in the low humidity environment (Comparative Examples 6 to 8).
(12) The large external addition amount of the barium titanate particles caused fog in the high humidity environment in the initial stage (Comparative Example 9), and the small external addition amount of the barium titanate particles failed to satisfy the remaining required amount in the final stage of the product life and caused an ID decrease in the low humidity environment (Comparative Example 10).
(13) The reduction of the average primary particle size of the barium titanate particles from 30 nm to 15 nm made the barium titanate particles difficult to be flowed into the depressions on the toner surfaces, and the remaining amount fell below the remaining required amount in the final stage of the product life, and a decrease in ID occurred (Example 11).
(14) The increase of the average primary particle size of the barium titanate particles from 30 nm to 45 nm reduced the surface area of barium titanate relative to the covered area, reduced the capability of improving the environmental charging performance, and caused an ID decrease (Example 12).
(15) With the use of the toner core particles with a viscosity at 90° C. of less than 100000 Pa·s, the remaining amount of barium titanate in the final stage of the product life fell below the required lower limit, and a decrease in ID occurred (Comparative Example 13).

### REFERENCE SIGNS LIST

1 Electrophotographic photoreceptor

31 Exposurer (semiconductor laser)

32 Charger (charging device)

33 Developing device

33a Developing roller

33b Casing

34 Transferer (transfer charger)

35 Fixer (fixing device)

35a Heating roller

35b Pressure roller

36 Cleaning device (cleaner)

36a Cleaning blade

36b Recovery casing

37 Separator

38 Housing

41, 42 Arrow

44 Rotation axis

51 Recording medium (recording paper or transfer paper)

100 Image forming device (laser printer)

1. A toner comprising:
toner core particles comprising at least a binder resin and a release agent; and
external additives externally added to surfaces of the toner core particles,
wherein
the binder resin comprises a crystalline polyester-based resin,
the toner core particles have a viscosity at 90° C. of 100000 to 250000 Pa·s,
the external additives are small size silica particles hydrophobized and barium titanate particles hydrophobized, and
the barium titanate particles have an average primary particle size of 20 to 40 nm and a coverage of 2 to 7% for the toner core particles.

2. The toner according to claim 1,
wherein the toner core particles have a BET specific surface area of 0.5 to 2.5 m²/g defined in JIS Z8830: 2013.

3. The toner according to claim 1,
wherein an average primary particle size PS of the small size silica particles and an average primary particle size PB of the barium titanate particles satisfy a relationship of PS<PB.

4. The toner according to claim 1, wherein when the toner is subjected to an external additive removal treatment and SA2 and SB2 are measured by X-ray fluorescence analysis, an adhesion strength (SA2/SB2)×100 of the barium titanate particles is 80% or greater where
SA2 is an intensity of elementary barium Ba in 1 g of a resulting toner after the external additive removal treatment,
SB2 is an intensity of elementary barium Ba in 1 g of the toner before the external additive removal treatment, and
the external additive removal treatment includes
adding 2.0 g of the toner to 40 mL of a poly(oxyethylene) octylphenyl ether aqueous solution with a concentration of 0.2 mass % to form a mixed solution and stirring the mixed solution for 1 minute,
irradiating the stirred solution with an ultrasonic wave with an output of 40 μA for 4 minutes,
allowing the irradiated solution to stand for 3 hours,
separating the toner and the external additives released,
removing a supernatant from the separated solution,
adding about 50 mL of pure water to a precipitate of the separated solution to form a mixture and stirring the mixture for 5 minutes,
suction-filtering the stirred mixture using a membrane filter with a pore size of 1 μm, and
vacuum-drying the toner remaining on the membrane filter overnight to produce the resulting toner after the external additive removal treatment.

5. The toner according to claim 1, wherein when the toner is subjected to stirring treatment and FA and FB are measured, a mobility (FB/FA)×100 of the barium titanate particles is 1.1 or less,
where
FB is an adhesion strength of barium titanate of a resulting content of the toner after the stirring treatment,
FA is an adhesion strength of barium titanate of the toner before the stirring treatment, and the stirring treatment includes
placing 50 g of the toner in a stainless-steel container with a capacity of 500 mL, and
stirring the toner in a stainless-steel container at a circulating speed of a stirring blade tip of 40 m/s for 180 seconds.

6. The toner according to claim 1, wherein when the toner is subjected to a qualitative and quantitative analysis with a scanning electron microscope and BF and BH are measured, a distribution deviation value (BH/BF) of the barium titanate particles is 2.0 or greater, where
BF is an average value of proportions of elementary barium Ba in flat portions,
BH is an average value of proportions of elementary barium Ba in depressed portions, and
in the qualitative and quantitative analysis, for 50 particles of the toner, two depressed portions, such as a step and a groove, and two flat portions with no depression on a surface of each of the 50 particles, 200 points in total are analyzed.

7. The toner according to claim 1,
wherein the toner core particles have an average primary particle size of 5 to 7 μm, and the small size silica particles have a coverage of 70 to 90% for the toner core particles.

8. A method for producing the toner described in claim 1, the method comprising:
externally adding the external additive to the toner core particles by adding and mixing the external additive of the barium titanate particles to the toner core particles; and
externally adding the external additive to the first externally added toner core particles by further adding and mixing the external additive of the small size silica particles to the first externally add toner core particles.

9. The toner according to claim 1, further comprising, as an external additive, large size silica particles with an average primary particle size of 70 to 200 nm.

10. A method for producing the toner described in claim 9, the method comprising:
externally adding the external additive to the toner core particles by adding and mixing the external additive of the barium titanate particles to the toner core particles;
externally adding the external additive to the first externally added toner core particles by further adding and mixing the external additive of the small size silica particles to the first externally added toner core particles; and
externally adding the external additive to the second externally added toner core particles by further adding and mixing the external additive of the large size silica particles to the second externally added toner core particles.

11. A developer comprising the toner described in claim 1 and a carrier.

12. An image forming device that forms an image by forming an electrostatic latent image on a surface of an electrophotographic photoreceptor and transferring a toner developed on the electrostatic latent image to a transfer receiving material,
wherein the toner is the toner described in claim 1.
